(19) United States
(12) Patent Application Publication
(10) Pub. No.: US 2001/0011305 A1
(43) Pub. Date: Aug. 2, 2001

(54) FILE TRANSMISSION ACKNOWLEDGEMENT SYSTEM AND METHOD

(76) Inventor: KEITH R. BARKER, BELMONT, CA (US)

Correspondence Address: JOYCE KOSINSKI, PATENT ADMINISTRATOR, LORAL SPACE AND COMMUNICATIONS, 655 DEEP VALLEY DRIVE SUITE 303, ROLLING HILLS ESTATES, CA, 90274

(21) Appl. No.: 09/255,603

(22) Filed: Feb. 22, 1999

(51) Int. Cl. G06F 15/173; G06F 15/16

(52) U.S. Cl. 709/237; 709/203; 709/223

(57) ABSTRACT

A file transmission acknowledgement system and method that indicates the success or failure of a file transfer from a content provider to client computers using a data distribution system. A transmitting processor transmits a file processed by a transmitting processor. One or more personal computers and/or server computers simultaneously receive the transmitted file by way of respective receivers. A reception algorithm on the server or personal computers determines if the file was successfully or unsuccessfully received by the respective computer. A receipt generation algorithm on the one or more server or personal computers generates a receipt acknowledgement or a receipt non-acknowledgement. A return path communication circuit is provided between the server or personal computers and the transmitting processor for delivering the acknowledgements to the transmitting processor. An algorithm on the transmitting processor collates the receipt transmissions. The algorithm also reformats the receipt transmissions for storage and viewing by content providers and personnel operating the data distribution system.

### BACKGROUND

The present invention relates generally to data distribution systems and methods, and more particularly, to a file transmission acknowledgement system and method for use in a data distribution system that indicates the success or failure of a file delivery.

The assignee of the present invention has developed a data distribution system, and in particular, a satellite-based data distribution system, that is used to distribute data supplied by content providers to personal computers of clients. In order to determine if file transfers have been properly performed between content providers and client personal computers using the data distribution system, an important aspect of the system was developed that addresses this need.

It would be advantageous to have a file transmission acknowledgement system and method for use in a data distribution system that indicates the success or failure of a file transfer from a content provider to client computers.

### SUMMARY OF THE INVENTION

The present invention provides for a file transmission acknowledgement system and method for use in a data distribution system. The file transmission acknowledgement system and method indicates the success or failure of a file transfer from a content provider to client computers.

The file transmission acknowledgement system comprises a transmitting processor for transmitting a file. One or more server or personal computers simultaneously receiving the transmitted file. A reception algorithm is provided on the server or personal computers that determines if the file was successfully or unsuccessfully received by the respective computers.

A receipt generation algorithm is provided on the server or personal computers that generates a receipt acknowledgement or a receipt non-acknowledgement. A return path communication circuit is provided between the server or personal computers and the transmitting processor for delivering the acknowledgements to the transmitting processor. A collating algorithm is provided on the transmitting processor that collates the receipt transmissions. The collating algorithm may also reformat the receipt transmissions for viewing by a user.

The file transmission acknowledgement method comprises the following steps. A file is transmitted from a transmitting processor. The transmitted file is simultaneously received at one or more server or personal computers. The received file is processed at the computers to determine if the file was successfully or unsuccessfully received. A receipt acknowledgement or a receipt non-acknowledgement is generated at the computers. The acknowledgements are delivered to the transmitting processor. The receipt transmissions are collated and optionally reformatted for viewing.

### BRIEF DESCRIPTION OF THE DRAWINGS

The various features and advantages of the present invention may be more readily understood with reference to the following detailed description taken in conjunction with the accompanying drawings, wherein like reference numerals designate like structural elements, and in which:

FIG. 1 illustrates an exemplary data distribution system for distributing data to personal computers in which the present invention may be employed;

FIG. 2 illustrates an exemplary file transmission acknowledgement system in accordance with the principles of the present invention; and

FIG. 3 illustrates an exemplary file transmission acknowledgement method in accordance with the principles of the present invention.

### DETAILED DESCRIPTION

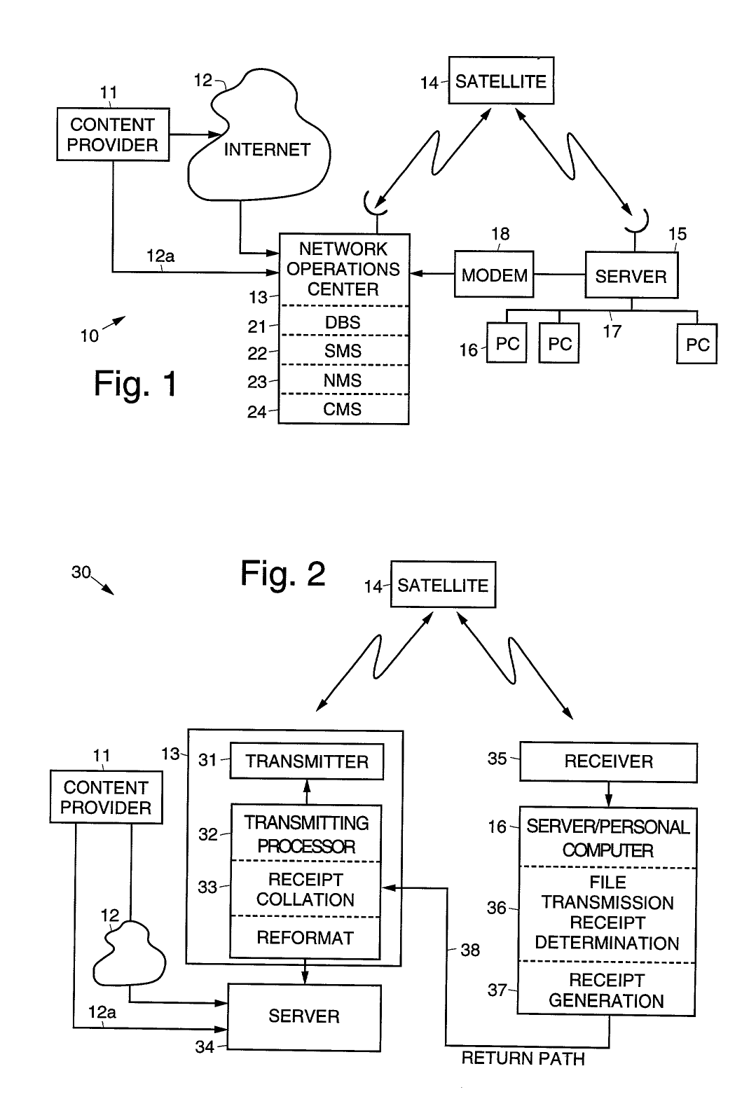

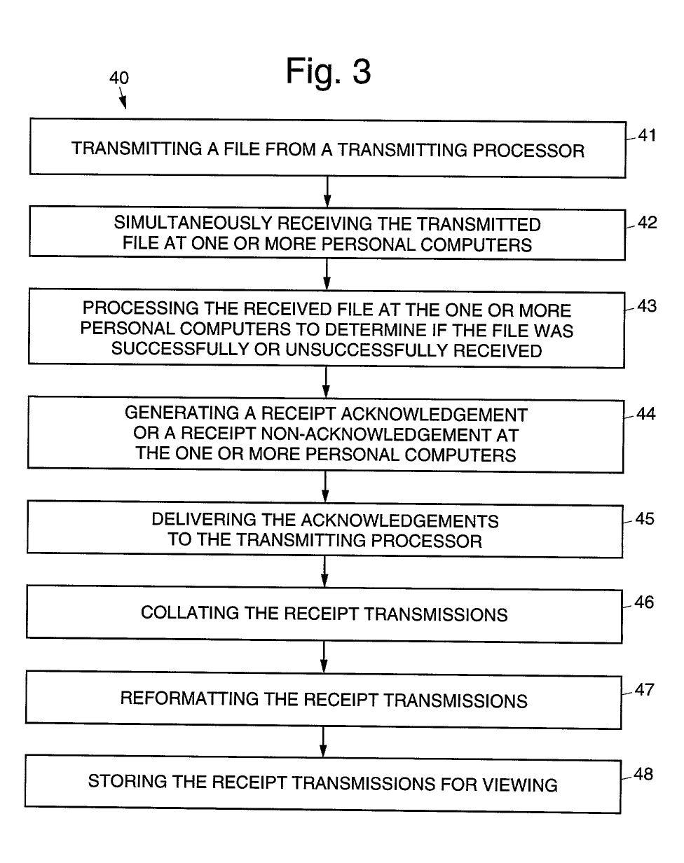

Referring to the drawing figures, FIG. 1 illustrates an exemplary data distribution system 10, illustrated as a satellite broadcast data distribution system 10, in which a file transmission acknowledgement system (FIG. 2) and method (FIG. 3) in accordance with the principles of the present invention may be employed. The exemplary data distribution system 10 is designed to distribute data (content) derived from one or more content providers 11 by way of a satellite 14 to client personal computers 16. The system 10 uses Internet protocol (IP) addressing to distribute the data to the personal computers 16.

The system 10 comprises a network operations center 13 that includes a data broadcast subsystem (DBS) 21, a subscriber management subsystem (SMS) 22, a network management subsystem (NMS) 23, and a content management subsystem (CMS) 24. One or more content providers 11 communicate by way of a direct line 12a or the Internet 12, for example, to the network operations center 13. The network operations center 13 communicates by way of the satellite 14 to the client personal computers 16.

The client personal computers 16 interface to the satellite 14 using satellite receiver PC cards (not shown) disposed in the client personal computers 16. Alternatively, the client personal computers 16 are connected to a local area network 17 and interface to the satellite 14 using a PC card disposed in a server computer 15 coupled to the local area network. The client personal computers 16 are also coupled by way of a modem 18 to the network operations center 13. The modem 18 provides a low-rate return path that is used to transmit requests from the client personal computers 16 to the network operations center 13 in order to download data derived from the content providers 11.

Each of the client personal computers 16 includes software that interfaces to the network operations center 13 and the content providers 11. The software is used to browse the Internet 12, send requests for data, control data download sessions, schedule delivery of data, and download streaming audio, video and data to the client personal computers 16 in real time, for example.

The system 10 and the software cooperate to establish a virtual private multicast network between the content providers 11 and the client personal computers 16. The system 10 and the software cooperate to provide managed electronic data delivery to multiple client personal computers 16. The system 10 and the software cooperate to provide both video and data download services with high efficiency.

FIG. 2 illustrates an exemplary file transmission acknowledgement system 30 in accordance with the principles of the present invention. The file transmission acknowledgement system 30 indicates the success or failure of a file transfer from the content provider 11 to the client server or personal computers 15, 16 as shown in FIG. 1.

The file transmission acknowledgement system 30 comprises a transmitting processor 31 for transmitting a file processed by a transmitting processor 32. One or more personal computers 16 and/or server computers 15 simultaneously receive the transmitted file by way of respective receivers 35. A reception algorithm 36 is provided on the server or personal computers 15, 16 that determines if the file was successfully or unsuccessfully received by the respective computer 15, 16.

A receipt generation algorithm 37 is provided on the one or more server or personal computers 15, 16 that generates a receipt acknowledgement or a receipt non-acknowledgement. A return path communication circuit 38 is provided between the server or personal computers 15, 16 and the transmitting processor 32 for delivering the acknowledgements to the transmitting processor 32. An algorithm 33 is provided on the transmitting processor 32 that may be used to collate the receipt transmissions. The algorithm 33 also reformats the receipt transmissions for viewing by respective content providers 11. The reformatted receipt transmissions are placed on a server 34 for storage and for subsequent viewing by content providers 11 and personnel at the network operations center 13. Content providers 11 access the formatted receipt transmissions by way of a router coupled to the direct line 12a, or the Internet 12, for example.

FIG. 3 illustrates an exemplary file transmission acknowledgement method 40 in accordance with the principles of the present invention. The file transmission acknowledgement method 40 comprises the following steps. A file is transmitted 41 from a transmitting processor 32. The transmitted file is simultaneously received 42 at one or more server computers 15 or personal computers 16. The received file is processed at the server or personal computers 16, 15 to determine 43 if the file was successfully or unsuccessfully received. A receipt acknowledgement or a receipt non-acknowledgement is generated 44 at the server or personal computers 16, 15. The acknowledgements are delivered 45 to the transmitting processor 32. The receipt transmissions are collated 46 on the transmitting processor 32, reformatted 47 and stored 48 on a server 34 for viewing by content providers 11 and personnel at the network operations center 13.

Thus, file transmission acknowledgement systems and methods for use in a data distribution system that indicates the success or failure of a file transfer from a content provider to client personal computers have been disclosed. It is to be understood that the described embodiments are merely illustrative of some of the many specific embodiments that represent applications of the principles of the present invention. Clearly, numerous and other arrangements can be readily devised by those skilled in the art without departing from the scope of the invention.

What is claimed is:

1. A system for indicating the success or failure of a file delivery, comprising:
a transmitting processor for transmitting a file;
one or more computers that simultaneously receive the transmitted file;
a reception algorithm that determines if the file was successfully or unsuccessfully received by the one or more computers;
a receipt generation algorithm that generates a receipt acknowledgement or a receipt non-acknowledgement; and
a return path communication circuit for delivering the acknowledgements to the transmitting processor.

2. The system recited in claim 1 further comprising an algorithm that collates the receipt transmissions.

3. The system recited in claim 1 further comprising an algorithm that stores the receipt transmissions for subsequent viewing.

4. The system recited in claim 1 wherein the collating algorithm reformats the receipt transmissions for viewing.

5. A file transmission acknowledgement method for indicating the success or failure of a file transfer from a content provider to one or more personal computers, comprising the steps of:
transmitting a file from a transmitting processor;
simultaneously receiving the transmitted file at one or more personal computers;
processing the received file at the one or more personal computers to determine if the file was successfully or unsuccessfully received;
generating a receipt acknowledgement or a receipt non-acknowledgement at the one or more personal computers; and
delivering the acknowledgements to the transmitting processor.

6. The method recited in claim 1 further comprising the step of collating the receipt transmissions.

7. The method recited in claim 1 further comprising the step of storing the receipt transmissions.

8. The method recited in claim 1 further comprising the step of reformatting the receipt transmissions for viewing.
